(19) United States
(12) Patent Application Publication
(10) Pub. No.: US 2006/0026554 A1
(43) Pub. Date: Feb. 2, 2006

(54) Ensuring consistency in an automation system

(76) Inventors: Martin Daimer, Erlangen (DE); Ludwig Karl-Dietze, Heroldsberg (DE); Andreas Macher, Neumarkt (DE); Siegfried Prieler, Tapfheim (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/193,947

(22) Filed: Jul. 29, 2005

(30) Foreign Application Priority Data
Jul. 30, 2004 (EP) 04018120.8

(51) Int. Cl. G06F 9/44

(52) U.S. Cl. 717/101

(57) ABSTRACT

The invention relates to a system and a method for storing project planning data (1, 2, 3) in an automation system (4) that contains automation devices (5, 6). To enable the consistency to be effectively ensured within the automation system (4), project planning data (1, 2, 3) is assigned to runtime data (7, 8, 9), with the project planning data (1, 2, 3) being accessible together with the runtime data (7, 8, 9) assigned to it and being stored in the automation devices (5, 6), whereby detection means for detecting changes to the runtime data (7, 8, 9) and to the project planning data (1, 2, 3) are provided and whereby test means for checking the relationships between the runtime data (7, 8, 9) and the project planning data (1, 2, 3) are provided.

### CROSS REFERENCE TO RELATED APPLICATIONS

This application claims priority to the European application No. 04018120.8, filed Jul. 30, 2004 and which is incorporated by reference herein in its entirety.

### FIELD OF INVENTION

The invention relates to a system and a method for storing project planning data in an automation system that contains automation devices.

### SUMMARY OF THE INVENTION

When an automation system is commissioned, project planning data is normally present, e.g. stored on a computer or programming device (PG) outside the automation system, and runtime data is stored in automation devices of the automation system. Project planning data and runtime data are consistent with each other at the time of commissioning. Normally, a copy of the project planning data, called a master project copy and designed for use as the basis of all subsequent modifications to the automation system, is stored by the user at this time to ensure data consistency. Ensuring consistency between project planning data and runtime data has up to now been the responsibility of the user. No system is known which ensures that changes that take place after commissioning of the automation system are automatically entered in the data of the master project copy. Such changes can, for example, be expansions to the plant, the occurrence of a servicing operation if there are problems in the plant, etc. Thus, it cannot be normally guaranteed that project planning data is always present that is consistent with the runtime data stored in the automation devices. This problem is normally tackled by providing the user of the automation system with procedural instructions designed to ensure a consistent procedure in the event of changes to the plant.

EP 1 347 376 A2 describes a system and a method for project planning of an automation system, whereby a project planning system with a uniform data model that is based on an object tree with hierarchically classifiable objects is used for uniform project planning combined with consistent data management.

The object of the invention is to enable consistency within an automation system to be effectively ensured.

This object is achieved by a system according to system claims. The system in accordance with the invention is used for storing project planning data in an automation system containing automation devices, with the project planning data being assigned to runtime data and the project planning data being accessible together with the runtime data assigned to it and stored in the automation devices, with detection means for detecting changes to the runtime data and the project planning data being provided, whereby test means for checking relationships between the runtime data and the project planning data are provided.

This object is further achieved by a method according to method claims. The method in accordance with the invention is used to store project planning data in an automation system containing automation devices, with the project planning data being assigned to runtime data, with it being possible to access the project planning data together with the runtime data assigned to it and the project planning data being stored in the automation devices together with the runtime data assigned to it, with changes to the runtime data and the project planning data being detected by detection means and with relationships between the runtime data and project planning data being checked by test means.

The invention enables the consistency between the runtime data on the automation system and the associated project planning data to be ensured. A user no longer has to take the trouble to implement measures to ensure consistency when there are modifications to the automation system. He is relieved of this task by the use of the system in accordance with the invention. The invention is based on the idea of initially storing the project planning data in one work operation, distributed in the automation system, with the project planning data being transmitted together with the runtime data assigned to it and being stored in the automation devices. The granularity of the loading process is such that the associated project planning data is always transmitted or stored for each object of the runtime data. This means that the current associated project planning data is always available to the user. If the user has made changes to the automation project, i.e. changed the project planning data, and wants to enter this changed project planning data in the automation system, the detection means of the system automatically detect the parts of the project planning data, i.e. in which engineering projects, to which changes have been made. By checking the relationships using the test means, the system is also able to determine what other project planning data is indirectly affected by the changes. When updating the runtime data in the automation devices of the automation system, all the changed and all the affected data—both the runtime data and the project planning data—is automatically loaded to the automation devices of the system. Consistency between the runtime data and associated project planning data is thus maintained even after the plant is modified.

The system and method in accordance with the invention determine a possible storage point of the master project copy in the automation system, for which all changes are subject to a mechanism for ensuring consistency. This offers advantages both to the user and to the project planner of the automation solution. The complete current project planning data, present in the plant consistent with the runtime data, is always available to the user. The online project planning data remains consistent for all plant modifications, and the responsibility for maintaining the consistency lies not with the project planner but is instead undertaken by the system.

In accordance with an advantageous embodiment of the invention, the project planning data is stored parallel to the runtime data assigned to it, distributed among automation devices assigned to the runtime data. This makes sure that the project planning and runtime data relevant to the particular device is available to the user in each automation device, even where there are communication faults in the communication network of the automation system.

To enable both plant expansions and also the connection of various applications, it is proposed that in accordance with a further advantageous embodiment of the invention the project planning data be stored in a generic, expandable data filing format.

Normally, it is not possible to access project planning data in an automation system while user programs are being executed. To enable access to project planning data in the automation system during the runtime, it is provided in accordance with a further advantageous embodiment of the invention that the project planning data also be such that it can be read and interpreted by the firmware of the automation system. For this, it is particularly advantageous if the firmware has a parser for interpretation of the data filing format in which the project planning data is stored.

Navigation through the complete automation project is enabled if, in accordance with a further advantageous embodiment of the invention, the firmware of the automation system has a generic interface for path-oriented access to project planning data stored in the form of a project tree. To speed up access to certain project planning data that is frequently requested, e.g. symbols and messages, in a further advantageous embodiment of the invention it is proposed that the firmware of the automation system has a specific interface with predefined access paths for access to stored project planning data.

In accordance with a further advantageous embodiment of the invention, the data storage format in which the project planning data is stored is specified by a predefined object model, represented by a project tree, and by pattern definition files.

The invention is described and explained in more detail in the following, with the aid of illustrations showing examples of embodiments.

### BRIEF DESCRIPTION OF THE DRAWINGS

FIG. 1 shows an automation system with automation devices,

FIG. 2 shows a schematic representation of the relationships between project planning data and runtime date,

FIG. 3 shows a schematic representation of the checking of relationships between objects, and

FIG. 4 shows an access to project planning data via a firmware interface.

### DETAILED DESCRIPTION OF THE INVENTION

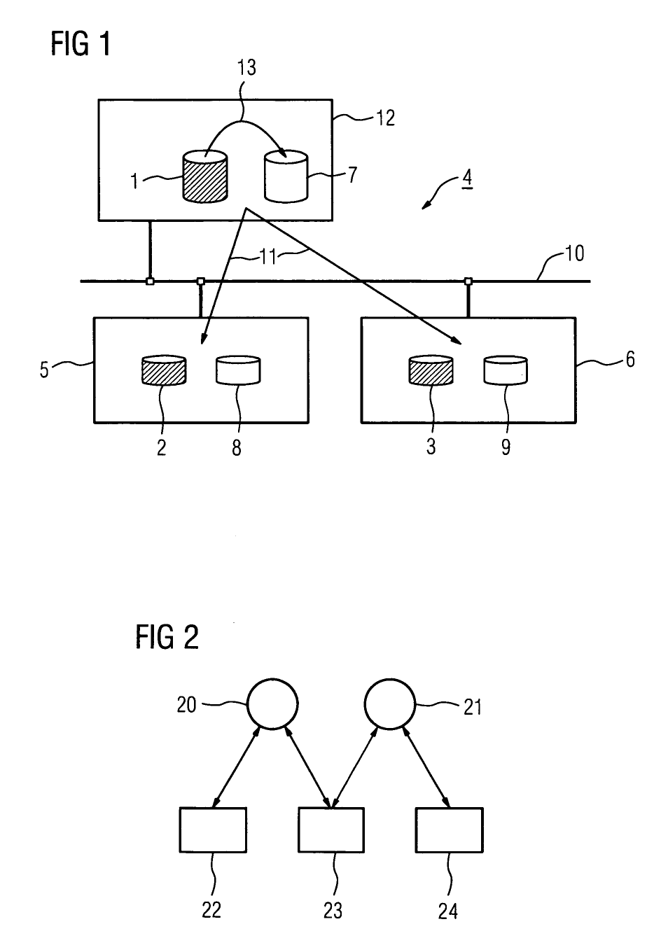

FIG. 1 shows an automation system 4 that contains automation devices 5,6 connected via a communication network 10, e.g. a bus system. A computer 12, e.g. a mobile programming device, is also connected to the communication network 10. The computer 12 is itself not part of the automation system 4. With the aid of the computer 12, a user creates project planning data 1 that is converted in a conversion step 13 into runtime data 7. The runtime data 7 contains executable program parts that, for example, represent a control program within the automation system. Up to now, the project planning tool and the project planning data generated by it were normally on a computer separate from the automation device, e.g. on a PC or programming device. Previously, only the pure runtime data, which however comprises only a small part of the information stored in the project planning data, was loaded to the automation system.

In accordance with the exemplary embodiment of the invention shown here, the project planning data 1 is present in a generic, expandable data storage format. Parts 2, 3 of the project planning data 1 are in each case assigned to specific parts 8, 9 of the runtime data 7. Parts 8, 9 of the runtime data 7 are in turn assigned in each case to an automation device 5 or 6 respectively. The arrows marked with the reference character 11 indicate the process of storage of parts 2, 3 of the project planning data or of parts 8, 9 of the runtime data. The parts 2, 3 of the project planning data are in this case stored parallel to the runtime data 8, 9 assigned to them, distributed among the automation devices 5, 6 assigned to the runtime data 8, 9 in each case. Both the project planning data 2, 3 and the pure runtime data 8, 9 is loaded to the automation devices 5, 6 of the automation system 4 in the case of all changes. This means that the project planning data is always consistent with the runtime data.

FIG. 2 shows an example of the relationships between project planning data and runtime data. The project planning data is present in the form of engineering objects 22-24, whereas the runtime data is present as runtime objects 20, 21. In the case shown, the runtime object 20 is formed from the engineering objects 22 and 23, and runtime object 21 from engineering objects 23 and 24. In the exemplary embodiment, the detection means for detecting changes to the runtime data and project planning data, as well as the test means for checking the relationships between the runtime data and the project planning data, are formed as something called a make function, that is explained in more detail in the following. If runtime data and/or project planning data is loaded, the relationships between the various changed runtime objects and engineering objects are checked by the make function. If the engineering objects have also been changed, the make function in a further step checks which runtime objects are affected by the change to the engineering objects. If further objects are found, an iteration procedure takes place until no new further runtime objects are found. This mechanism can be used for any loading operations, whether they are loading operations of project planning data or loading operations of runtime data.

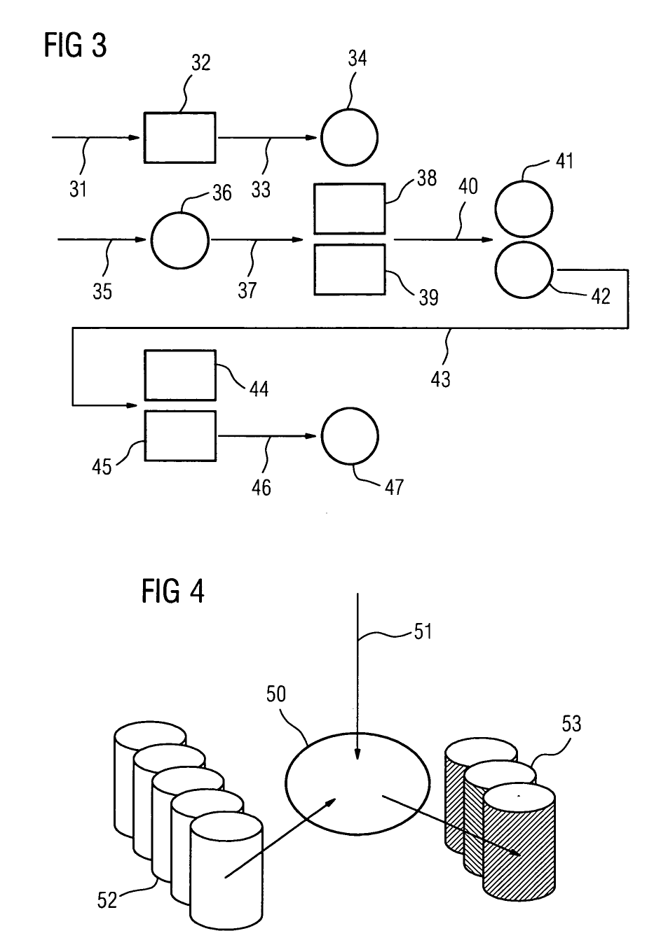

FIG. 3 is a schematic representation showing the checking of relationships between objects by means of a test means. An engineering object 32, that corresponds to the engineering object 22 from FIG. 2, is changed in a first step 31. In a second step 33, the engineering object is compiled so that a runtime object 34 is formed that corresponds to the runtime object 20 from FIG. 2. In a next step 35, the runtime object 34 changed in this way is loaded as runtime object 36 to the automation device assigned to it. In the next step 37, the test means, e.g. the aforementioned make function, searches for relationships and as a first result the relationships between the runtime object 20 and the engineering objects 22, 23 are determined according to FIG. 2. The determined engineering objects dependent on the runtime object 36 are shown in FIG. 3 by the reference characters 38 and 39. In the next step 40, an automatic search for the relationships of the engineering objects takes place. As a result, the already-known runtime object 20 in accordance with FIG. 2 and runtime object 21 in accordance with FIG. 2 are determined. In a next step 43, a check is again carried out to determine what relationships the runtime object 42 has, and as a result the engineering objects 23, 24 are determined according to FIG. 2. In a next step, relationships of the engineering object 24 or 45 are determined according to FIG. 3, in this case the runtime object 21 according to FIG. 2 or 47 according to FIG. 3. The result of the relationship check is thus that when loading the runtime object 20 the engineering objects 22, 23 and 24 as well as the runtime object 21 are also loaded, because these objects are connected to one another by relationships and are thus affected by the changes to the engineering object 22 or runtime object 20.

FIG. 4 shows access to project planning data 53 via a firmware interface 50. In this case, an access 51 to the project planning data 53 takes place from outside the automation device via a firmware interface 50. Changes to the runtime data 52 of the automation device are also passed via the firmware interface 50 to the project planning data 33, stored in the automation device.

This means that the project planning data 53 is stored in the central processing unit (CPU) of the automation device consistent with the runtime data 52 and is also held consistent in the event of changes. It is stored in a generic data storage format (e.g. XML) in the form of modules. This means that its structure is known in principle. New access functions can now enable access to the project planning data 53 via the standard communication paths of the CPU without it having to be uploaded and interpreted in the programming device. This is achieved via the firmware of the automation system. To make an access of this kind possible, a simple parser for the generic data tree is implemented there, that enables the data to be navigated via firmware functions. An interface in the automation device that provides the methods Up, Down, Next, Value and Attribute is sufficient for navigation.

Two different firmware interfaces are defined. One is a generic interface. In this case, a basic knowledge of the storage format in principle is presumed. In principle, this interface enables navigation through the complete project tree. The input parameter is, for example, an XPATH expression and the result is the result of the evaluation. A special interface is also defined. To increase performance, access paths to specific project planning data that is frequently requested are predefined here. Examples of this are symbols and messages. Both interfaces realize different methods for accessing the user data. New library functions can be made available for access to the project planning data from the user program. In this case access is made directly to the project planning data via the firmware. Firmware interfaces realized in this way enable project planning tools to be based on the project planning data stored in the automation device, without having to load it. In this case it is important that the tools need to contain only basic information regarding the filing system of the data on the automation device in order to be able to load the data. If this is the case, the power and efficiency of these tools is increased, without having to unnecessarily complicate the system by proprietary data formats and expensive data manipulation.

The immediate result of this is that the previous project planning by the user can now be used as an input. This data does not have to be reentered and information from this data can be used for default settings. Further application scenarios for automation systems with the proposed firmware interfaces are as follows:

Project planning or library functions in the user program can be accessed from modules directly at runtime via interfaces of the CPU firmware, and if necessary can then also be reloaded. Thus, an interface in the firmware enables the automation system to directly access the data of the offline hardware project planning. The parameterization of the CPUs is in this case stored in the project data in the form of HEX dumps of binary data. A simple access thus enables the parameterization of a device to be determined.

HMI devices can directly access data of the user project in order, in this case, for example, to fetch the required symbol information or newly defined messages.

The interface represents a standard access path for diagnosis via web servers. Accessing the project planning data at runtime offers a simple possibility of meeting the requirements without having to define new workarounds.

The interface can be used for the purposes of configuration management: the required information (e.g. timestamp, comments, names, etc.) can be obtained via the project planning data. By using the configuration management it is then possible to automatically check the actual configuration of an automation system. To do this, it is necessary, for example, to request version information for the program (or for individual parts). Because the consistency of the project planning data relative to the runtime data is ensured, the actual configuration (of the user programs) can be obtained from the information in the project planning data.

By storing this data it is possible to carry out expansions to the project planning data that are consistent in the runtime environment, and that would then likewise be stored in the automation device.

It is thus possible to access the project planning data directly via interfaces in the firmware of an automation system. In this case, it is immaterial whether the accessing device is a program presently running on the automation device or an external tool on a programming device. The access interface in the firmware of the automation device makes sure that the requested project data is always made available. The project planning information can be used by different clients. The purpose for which it is used is immaterial.

To sum up, the invention thus relates to a system and a method for storing project planning data 1, 2, 3 in an automation system 4, that contains automation devices 5, 6. To enable effective consistency to be ensured within the automation system 4, the project planning data 1, 2, 3 is assigned to runtime data 7, 8, 9, with it being possible to access the project planning data 1, 2, 3 together with the runtime data 7, 8, 9 assigned to it and stored in the automation devices 5, 6, with detection means for detecting changes to the runtime data 7, 8, 9 and to the project planning data 1, 2, 3 being provided and test means for checking the relationships between the runtime data 7, 8, 9 and the project planning data 1, 2, 3 being provided.

1-16. (canceled)

17. A system for storing project planning data in an automation system containing automation devices, wherein
the project planning data are assigned to runtime data, wherein
the project planning data are accessible together with the runtime data, and wherein
the project planning data are stored in the automation devices, the system comprising:
a detection mechanism for detecting changes to the runtime data and the project planning data; and
a test mechanism for checking the relationships between the runtime data and the project planning data.

18. The system in accordance with claim 17, wherein the project planning data is stored parallel to the runtime data assigned to it in each case, and wherein the project planning data is stored in a distributed manner among the automation devices assigned to the runtime data.

19. The system in accordance with claim 17, wherein the project planning data is stored in a generic, expandable data filing format.

20. The system in accordance with claim 17, wherein the project planning data can be read and interpreted by a firmware of the automation system.

21. The system in accordance with claim 17, wherein a firmware of the automation system comprises a parser for interpretation of the data filing format in which the project planning data is stored.

22. The system in accordance with claim 17, wherein a firmware of the automation system comprises a generic interface for path-oriented access to project planning data stored in the form a project tree.

23. The system in accordance with claim 17, wherein a firmware of the automation system comprises a specific interface with predefined access paths for access to stored project planning data.

24. The system in accordance with claim 17, wherein a data filing format in which the project planning data is stored is specified by a predefined object model, represented by a project tree and by pattern definition files.

25. A method for storing project planning data in an automation system containing automation devices, comprising:
assigning runtime data to the project planning data;
providing common access to the project planning data and the runtime data;
storing the project planning data in the automation devices together with the runtime data;
providing a detection mechanism for detecting changes to the runtime data and to the project planning data; and
providing a test mechanism for checking relationships between the runtime data and the project planning data.

26. The method in accordance with claim 25, wherein the project planning data is stored parallel to the runtime data assigned to it in each case, distributed among the automation devices assigned to the runtime data in each case.

27. The method in accordance with claim 25, wherein the project planning data is stored in a generic, expandable data filing format.

28. The method in accordance with claim 25, wherein the project planning data is readable and interpretable by a firmware of the automation system.

29. The method in accordance with claim 25, wherein a firmware of the automation system can interpret the data filing format in which the project planning data is stored by a parser.

30. The method in accordance with claim 25, wherein by means of a generic interface of a firmware of the automation system, path-oriented access is possible to project planning data represented in form of a project tree.

31. The method in accordance with claim 25, wherein by an interface of a firmware of the automation system it is possible to access stored project planning data via predefined access paths.

32. The method in accordance with claim 25, wherein a data filing format in which the project planning data is stored is specified by a predefined object model, represented by a project tree, and by pattern definition files.
